(19) United States
(12) Patent Application Publication
(10) Pub. No.: US 2025/0095058 A1
(43) Pub. Date: Mar. 20, 2025

(54) DYNAMIC AUCTION AND COMMUNICATION PLATFORM

(71) Applicant: Ian D'Arcy, Amenia, NY (US)

(72) Inventor: Ian D'Arcy, Amenia, NY (US)

(21) Appl. No.: 18/890,183

(22) Filed: Sep. 19, 2024

Related U.S. Application Data
(60) Provisional application No. 63/539,507, filed on Sep. 20, 2023.

(51) Int. Cl. G06Q 30/08; H04L 51/04; H04N 7/15

(52) U.S. Cl. CPC G06Q 30/08; H04L 51/04; H04N 7/15

(57) ABSTRACT

A live auction platform for real time display of multimedia content of an item up for auction and contemporaneous streaming of live auction participant video according to the participant's bid status and real time updating of a communication thread among auction participants concerning the status of the auction and the bidding participants, with display of a participant video stream with the display and updating of the communication thread.

### CLAIM OF PRIORITY

This application claims priority to U.S. Provisional Application No. 63/539,507 filed Sep. 20, 2023, and is incorporated by reference herein in its entirety.

### TECHNICAL FIELD

This disclosure relates generally to systems and methods for providing a product auction site. In particular, the disclosure relates to a high-end vehicle auction platform with a dynamic communication posting capability for auction platform user's to post messages concerning auction items and results.

### BACKGROUND

Interest in automobiles is high and particularly so for high-end and custom vehicles. Currently, demand for such vehicles is high while supply has always been low and such vehicles, by definition, are rare. Those possessing such vehicles wishing to monetize their investment often put the vehicles up for auction to get many individuals involved in the purchase process and to maximize the sellers return on investment.

Vehicle auctions are known and in-person auctions allowing remote bidders to participate have occurred in recent years via the Internet. Typical vehicle auctions are held in person. Although those interested in bidding may do so remotely via telephone or bidding online over the Internet, the remote bidder does not experience anywhere near the electricity and excitement of those participating in person. This is because for auctions where many bidders attend in person, the remote bidder is somewhat of an afterthought when it comes to giving remote bidders a rich, auction experience. The systems and methods of the auction and communication and multimedia platform disclosed and described herein account for the shortcomings of current auction venues and provide bidders with numerous opportunities for post vehicle purchase of goods and services.

### BRIEF DESCRIPTION OF THE DRAWINGS

The novel features believed characteristic of the invention are set forth in the appended claims. The invention itself, however, as well as a preferred mode of use, further objectives and advantages thereof, will be best understood by reference to the following detailed description of illustrative embodiments when read in conjunction with the accompanying drawings, wherein:

FIG. 1 is a network diagram of an auction platform according to an embodiment.

FIG. 2 is a diagram of an auction user interface according to an embodiment of the presently described auction platform:

FIG. 3 is a diagram of an auction management system interface according to an embodiment of the presently described auction platform;

FIG. 4 is a diagram of a vehicle sale listing user interface according to an embodiment of the presently described auction platform;

FIG. 5 is a flow diagram of a method of conducting an auction according to an embodiment of the presently described auction platform;

FIG. 6 is a diagram of a user commentary section of an auction user interface according to an embodiment of the presently described auction platform.

### DETAILED DESCRIPTION

Several embodiments of Applicant's invention will now be described with reference to the drawings. Unless otherwise noted, like elements will be identified by identical numbers throughout all figures. The invention illustratively disclosed herein suitably may be practiced in the absence of any element which is not specifically disclosed herein.

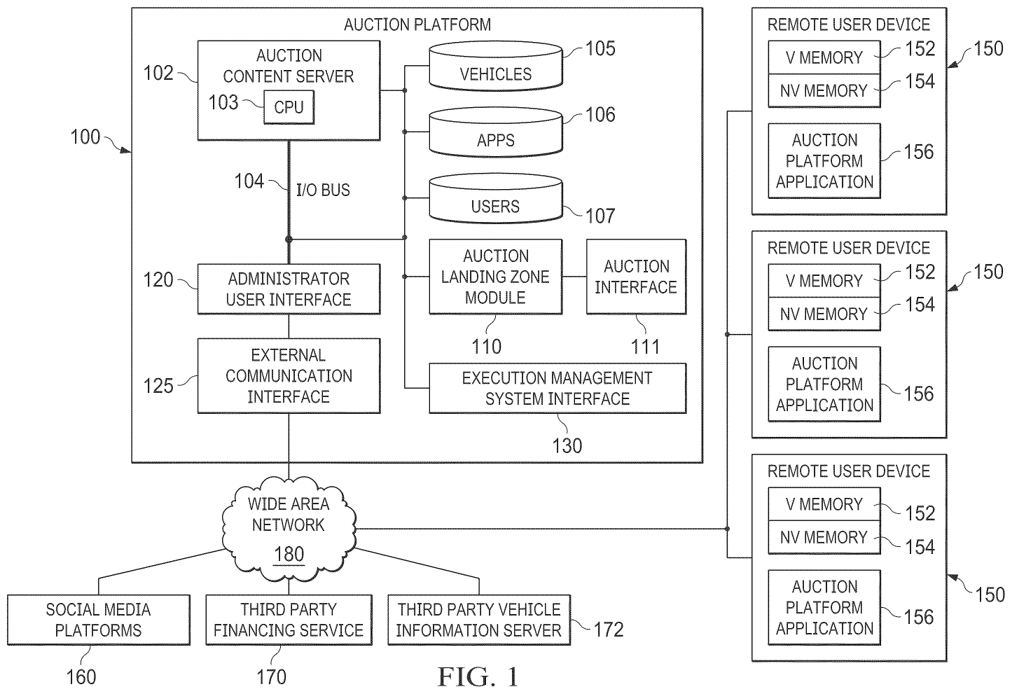

Embodiments of the present disclosure and its advantages are best understood by referring to FIGS. 1 through 6 of the drawings, like numerals being used for like and corresponding parts of the various drawings.

In one embodiment, the system is embodied in one or more application programs executed on a computer, smart phone, tablet or any device having communication network connectivity via a wired or wireless network and/or internet capability. The application program operates as a computer platform through which information concerning items up for auction, such as vehicles, is pushed to or requested by users having a customized application program stored on a mobile device, such as a smartphone, tablet, personal digital assistant or the like. Information related to a vehicle up for auction or of an owner of such a vehicle is transmitted to a user enrolled and approved as a bidder by the operator of the online auction. User enrollment requires a monthly subscription arrangement where the user pays a monthly fee to remain active as a bidder. Alternatively, a lump sum payment is made by the user to permit access and use of the presently described auction platform for a predefined length of time, with the finite period extendable by the user according to terms offered by the auction platform operator.

Users enrolling in an auction platform of the present invention have the option of enrolling in an advertisement free service plan or one in which advertisements are transmitted to the user's device. The advertisement free service plan typically is more costly than the “with ads” service, with the “with ad” service being offered for free or at a low monthly payment, as is the choice of the platform operator. As will be described, the platform operator of the presently described auction platform offers many customizable programs to user, enabling subscribing users to purchase and activate features or select products or services through a dedicated application program that provides the most effective manner to receive auction content of interest.

The presently described auction platform is a robust system providing auction administrators with a highly customizable auction setting and associated services for its participants. A technological advancement is computerized auction platforms is achieved by providing, among other things, a user interface and user experience generating platform including real-time video feeds that are dynamically updated according to the amount of a bid from various users received by the auction platform. With each new bid, a video stream of the current high bidder and most recently overtaken bidder is inserted into the user interface of all users participating in the bidding. In addition, live commentary and a video stream of the commenting user is also inserted into the interface, dynamically updated as new comments by the same or new commentators are posted to the platform.

In one embodiment, the presently described auction platform centers upon high priced or collectable vehicles. The bidding process is not an “open bidding” process but restricted to pre-authorized bidders who pass a multi-faceted pre-approval process. Once a user is enrolled according to a pre-established enrollment criteria defined by the auction platform administrator, the user gains access to an auction landing zone. In one embodiment, the user enters his or her unique credentials via a specially dedicated user interface made available to the user via a dedicated auction platform application program stored in memory on the user's device.

FIG. 1 is a network diagram of an auction platform according to an embodiment. In FIG. 1, auction platform 100 performs or causes to be performed much of the features and functionality of the presently described invention. Auction platform 100 comprises auction content server 102, that itself comprises a central processing unit 103 and has associated databases, specifically vehicles database 105, applications database 106 and user database 107. Input/output bus 104 enables communication by and between components of the auction platform 100. User interface 120 communicates with auction content server 102 via input/output bus 104 and with external systems, databases, servers and the like via external communications interface 125. Vehicle database 105 includes data concerning various vehicles up for auction, as will be discussed. Users database 107 includes information concerning users who have been assigned unique participant credentials, such as a unique combination of a username and an account password. Users are pre-approved to bid in auctions and use the participant credentials assigned or selected by the user to view vehicles up for auction and bid on such vehicles through the auction user interface. Applications database 106 includes various application programs that enable various features of the presently described auction platform, for use by auction participants or auction administrators to enhance the auction experience. User database 107 further includes user information such as user account information that in one embodiment includes a user's associated financial account information through which users make payment for the services offered through auction platform 100, as well as user preferences and profile information. The user in one embodiment is assigned a unique identifier that is based on an email address, a phone number or other unique combination of numbers, letters or special characters that uniquely identifiers a user establishing service with auction platform 100.

User database 107 also contains user information provided by the user, such as various user attributes. This includes the user's address, phone number, and contact information. The user optionally provides more detailed demographic information such as age, gender, and various user interests. These attributes are aggregated by the platform operator and through predictive software modules stored in applications database 106, the user is provided with various items of interest. These items of interest include but are not limited to other vehicles of interest, upcoming auctions, other vehicle products available for purchase, current location of vehicles for sale that may be of interest to the user and available for viewing, and the like.

User datastore 107 contains user information submitted by the user when subscribing to the auction platform 100 service. User information includes a username and a login password as is customary, that serves as a unique identifier of the user of the platform. The user information also includes user financial account information through which a flat fee or monthly subscription fee is paid to the auction platform operator from the user. The financial information can be credit or debit card information, bank account information, such as a bank account number of the user from which payments are drawn, a gift card number, a third-party payment vendor (such as PayPal), or payment may be made by application programs associated with the user's device, such as Google Wallet or Apple Pay. Other known payment avenues may be employed and the user submits the relevant payment account information to the auction platform operator to facilitate payment, with such information stored in user database 107.

Execution management module 130 comprises various subcomponents of the auction platform to provide authorized users various ancillary services in connection with vehicles that a user may be interested in bidding on or ultimately winning via the auction platform, as will be described. Application programs 106 include various software modules or code that when executed causes various features and functionality of the auction platform 100 to be invoked.

In particular, application programs 106 comprise computer readable code stored in non-volatile memory associated with processor 103 of auction content server 102. Execution of the computer readable code causes the various software modules governing operation of the auction platform to be invoked and control the functionality of the auction platform.

Vehicle database 105 includes content related to auction information such as information concerning each vehicle up for auction, including the make and model of the vehicle, the mileage of the vehicle, a calculated rarity score of the vehicle, vehicle specification data and multimedia files regarding the vehicle. Other content in vehicle database 105 includes vehicle location information, seller information, title history of the vehicle, data concerning the auction information previously sent by auction platform 100 to users or other parties.

Content selection application programs of application programs 106 cause transmission of auction data or other content, such as live video feeds of auction participants and commentators, to be inserted in the auction user interface.

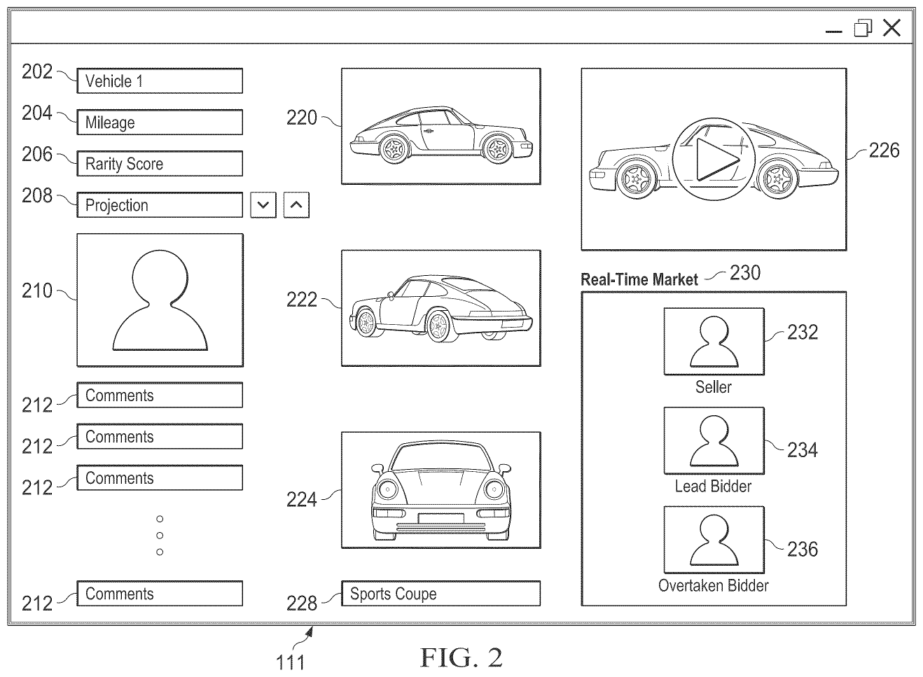

Embodiments of the features and functionality of auction platform 100 that are carried out by execution of application programs 106 and the dedicated auction platform application program stored on the mobile user device are described in detail in FIGS. 2-5.

The contents of the various databases 105, 106 and 107 are stored in a single datastore, in separate datastores as described or stored together in a single storage location, or either locally in relation to auction content server 102 or remotely, accessible over network 180, such as in distributed or cloud storage means.

Auction server 102 communicates with external devices via external system interface 125. Communication between platform 100 and mobile users 150 and third-party social media platforms 160, third party vehicle information server 172 and third-party financing service 170 occurs via wide area network 180, which includes the internet and/or a cellular network or the like. Such external platforms include financial networks (not shown) as part of third-party financing service 170 to process user payments, social media platforms 160, third party vehicle information sources (not shown) and the like.

Auction administrators communicate with auction content server 102 via administrator interface 120. Through administrator interface 120, the administrator sets the various parameters of the auction, including the vehicles that will be up for sale in the auction, the time parameters of the auction, selection of multimedia content regarding the vehicles and vehicle information that will be displayed in connection with the vehicle up for auction and other auction parameters.

Auction landing zone module 110 presents an auction interface 111 to the participating user in the auction and content commensurate with the auction process. Landing zone module 110 executes one or more application programs stored in application program database 106 to populate the contents of user interface 111. The contents of the auction interface 111 are presented according to the administrator's selections. In an embodiment, the auction interface 111 comprises a plurality of vehicles up for auction. In association with each vehicle, user selectable links direct the landing zone module to present additional real time content to the user. A user, for example, is presented with a plurality of vehicles up for auction. The vehicles are presented as a listing, with or without one or more photographs upon selection of an indicator of the vehicle, such as a photograph, a text link, or a combination of the two, the user is directed to a webpage that provides the user with more granular information concerning the vehicle up for auction and the status of the auction.

Continuing with FIG. 1, in one embodiment, an auction landing zone module 110 provides to a user auction interface 111 via the user's display on a computer, personal digital device or mobile device 150. The user receives auction interface 111 via a dedicated auction platform application program 156 residing on the mobile device 150. Auction landing zone module 110 receives customization from the platform administrator to control the interface presented to the user. Auction platform application programs 156 include executable instructions that the user downloads to the mobile device that when the instructions are invoked cause the display screen of the user device to include auction interface 111, with the detailed fields as described below with reference to FIG. 2. Mobile device 150 also includes volatile memory 152 and nonvolatile memory 154 to serve as storage locations for auction platform application programs 156 and other data input by the user in connection with the auction process, as will be described.

Auction platform 100, and, in particular, auction landing zone module 110 communicates with mobile devices 150, third-party financing service network 170, social media platforms 160 and other peripheral participants via external communication interface 125 over network 180. Mobile device 150 is equipped with a camera that permits users to store and upload to auction platform 100 images and video of vehicles of interest and allows users to participate in live auctions via auction interface 111 with user video streaming in real time as the auction ensues, as will be described.

User database 107 includes user data provided by an approved bidder in auctions performed by the presently described auction platform. User database 107 includes user defined parameters applied to vehicles for which the user is interested in bidding. The user defines a maximum bid for a particular vehicle or auction, the increments by which the user wishes to increase a bid, and particular vehicle types that are of interest in order for auction platform 100 to send the user updates on upcoming auctions in which a vehicle of interest is schedule to be up for auction and other vehicle of interest information.

User information also includes financial information pertaining to the user, including pre-approval information for the auction administrator to gauge whether the user should be given credentials to participate in the bidding process. User information also includes bank account, or credit card information from which funds are drawn to pay for vehicles that the user won at auction or chooses to purchase via the gallery facet of the auction platform 100, as will be described. User information is communicated over a wide area network 190 through mobile devices 150, which are smart phones, personal computers or personal digital assistants or other user devices having a processor and operating system. Mobile device 150 also includes a radio or receiver in a user's vehicle. Through an application program installed in storage connected with the user's vehicle media system, the user can execute the functionality of offered through auction platform 100 and the dedicated application programs downloaded by the user via the user's vehicle display and corresponding controls. That is, the vehicle's entertainment system has stored thereon the same auction mobile applications 152 as would be downloaded on the user's smartphone device.

Similarly, the user electing to install the vehicle entertainment system version of auction mobile applications will listen to content including audio files relating to the auction through the vehicle's speakers connected to the radio or entertainment system. For purposes of the discussion of the methods of the embodiments discussed below, it is assumed the mobile user device is a smartphone but a user radio/entertainment system is equally effective as the receiver of the information. Moreover, the user of a mobile device that is a smart phone can link the smartphone to the vehicle entertainment system via the Bluetooth network protocol or other known wireless or wired network protocol, enabling viewing of content received from auction mobile applications 152 on the vehicle's screen, through the vehicle's speakers and the like.

Auction platform application program 156 is downloaded to the user mobile device 150, whether laptop computer, tablet, smartphone or other device, by the user from known platforms from which users upload application programs and is stored in non-volatile memory 154 of mobile device 150. Auction application program 152 provides a graphical user interface on the display of mobile user device 150 making the various user selectable features and functionality of auction platform 100, and ultimately content of interest and auction interface 111, available to the user on mobile user device 150. It is assumed that users of mobile user devices 150 are subscribers to various networks such as a cellular network or have available wired or wireless communications in the case of a personal computer to communicate with auction platform 100 via wide area network 190.

Mobile user device 150 also comprises volatile memory 155, in which certain data and information is presented to the user and made available while the mobile device is powered on and auction platform application program 156 is open and running. Such information that is stored temporarily for the user in volatile memory are uploaded photos or profile or preference selections or other information retrieved from non-volatile memory to provide the user with the ability to make additional use of such information.

In an embodiment, a third-party vehicle information server 172 communicates with auction platform 100 via network 180. Third party vehicle information server 172 is associated with a single third-party or multiple third-parties to provide content to auction platform 100. In this context, auction platform 100 acts as an information aggregator of content retrieved from third party vehicle information server 172. Such content includes various pre-produced audio and video content regarding various vehicles up for auction, specification data of the vehicle, manufacturing information for particular vehicles and the like. Additional items such as audio books or films or other produced content is retrieved by auction platform 100 and saved in content database 107 for ultimate access by a subscribing mobile user. The operator of auction platform 100 can purchase or license third-party content for use during auctions or as an informational source to users. Auction platform 100 makes requests for information from third party auction server 102 communicates via external communication interface 125.

Continuing with FIG. 1, in an embodiment mobile devices 150 and auction platform 100 communicate with various social media platforms 160 via network 180. Social media platforms 160 communicate with auction platform 100 enabling the operator of auction platform 100 to have its own presence on various social media outlets to promote platform 100 and its offerings. At the same time, users via mobile user devices 150 access their respective social media accounts directly through the auction platform application program 156 installed on mobile device 150. This allows direct postings by the user of content or information gleaned during the auction experience via auction platform 100 in a most efficient manner.

FIG. 2 is a diagram of an auction user interface according to an embodiment of the presently described auction platform. Auction interface 11 in one embodiment is generated by auction content server 102 in conjunction with auction platform application program 156 residing on user device 150. Auction interface 111 in an embodiment is generated by auction landing zone module 110 as displayed on user mobile device 150. Auction interface 111 comprises numerous fields containing various static and dynamic data to the user as well as digitized data such as photos and video content of vehicles up for auction. In addition, auction interface 111 includes fields for live streaming video and audio of user bidders in the auction and other participants. Dynamic data is updated in real time giving users an in person feel of an auction setting but with enhancements such as real time commentary that not even a live auction provides.

In FIG. 2, vehicle identification field 202 provides information about the vehicle, such as the make, model and year of the vehicle that is up for auction. Mileage field 204 provides the current mileage of the vehicle for auction. Rarity score field 206 provides a rarity value associated with the vehicle listed in vehicle identification field 202. Rarity score is a value within a low to high range, such as one to ten, with ten indicative of the highest level of rarity of the vehicle up for auction, which increases the vehicle's value. Rarity score is comprised of various vehicle data in one embodiment retrieved from third party vehicle information server 172 and aggregated by auction platform 100. This data includes the number of vehicle models overall manufactured and the number in the particular color manufactured. Projection field 208 is provided that includes an indicator of the projected value for the vehicle. The projection is a projection that the of the value of the vehicle that is to be higher or lower than the stated value for the vehicle. An “up arrow” or “down arrow” is displayed in projection field 208 indicating the expected trend of the bidding in relation to the stated value of the vehicle. The projection indicator in projection field 208 is static in one embodiment and established prior to the auction. In another embodiment, the projection indicator in projection field 208 is dynamic in that it changes during the auction based on changes in market conditions or other variables during the auction.

Auction interface 111 further includes a commentary section where users are able to post comments and responsive discussion statements concerning the status of a vehicle up for auction and the events of the auction. Commentator field 210 comprises a video field in which a live video image of the user while posting a comment or providing an audio comment is displayed. The commentator comment is transcribed into textual form and presented in a SMS message type of format in comment fields 212. The most recent commentator's comment is posted in the upper most comment field. The commentator's image changes as a different commentator posts a message. Older comments are purged as new comments are made. The final text string of a complete auction of a vehicle is saved to non-volatile memory of auction platform 100 for later viewing enjoyment of users, memorializing the commentary or “trash talking” and competition of the auction bidders.

As shown, commentator comments in one embodiment are presented in a single chat room or text string format in comments field 212. Such an arrangement would include comments from various users of the auction platform. These include sellers of vehicles, bidders of the vehicle up for auction, verified users (who are not bidding for this particular vehicle) and unverified users of the auction platform. To enhance the auction platform experience, unregistered users are invited to post comments during an auction. However, users of the auction platform, particularly the bidders, may wish to know which comments are made by unregistered users, registers users, bidders and sellers, in order to give the comments appropriate weight. In this regard, in one embodiment, when comments are all displayed in a single thread or chat room format, users are provided with a status indicator that is posted next to the commentator's identity. In one embodiment, the username of a commenting user who is not registered is presented in regular text. The commenting user who is verified, however, has his or her name posted with emphasis added, such as in bold text or underlined or in a color different than the unverified commenter. For bidders, who are also verified, a first medallion or other icon is added to the highlighted username. The seller's username is also distinguished from the others with a second medallion or icon. In this manner, in a single chat or text thread, a viewer of the auction commentary can distinguish the source of commentary of users of different verification status and roles.

In an alternative embodiment, the text string display is segregated among verified and unverified users as different strings—one for unregistered users and one for verified users. The latter includes comments of registered users, bidders and sellers. The usernames of each comment poster is highlighted and distinguished with different fonts, highlighting, emphasis and indicators or icons as discussed above. Of course, the username of a commentator is the ultimate indicator as any participant may regard or ignore the comment of any user based on either the status indicated or the personal knowledge of the poster.

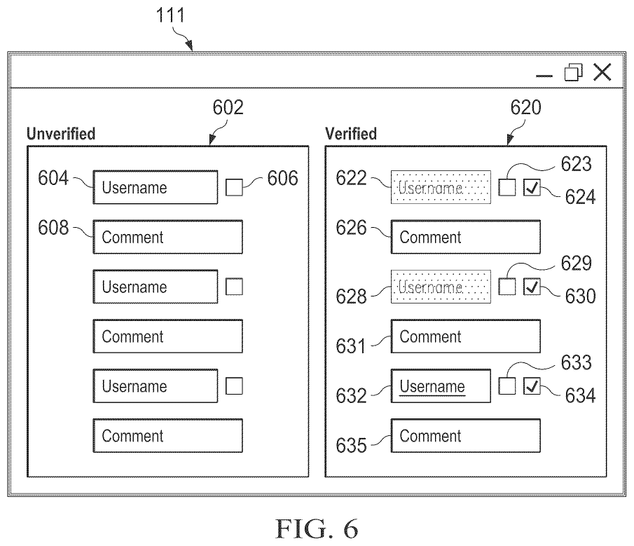

FIG. 6 depicts separate commentary strings with commenter designations that would appear in auction interface 111 according to an embodiment. In FIG. 6, a first text area 602 includes comments from unverified users. In first text area 602, an unverified user's username 604 and comment 608 are listed in real-time as users make comments. An icon area 606 is reserved for placement of an icon of the user, which is established by the user, giving others the ability to quickly differentiate one posting user from another.

Verified user's comments are posted in separate second text area 620. In second text area 620, a first verified username 622 is displayed with a first indicator, in this case, shading of the username that sets it apart from the other text, such as via different coloring or shading. Next to first verified username 622 is first icon area 623 that will include an indicator selected by the user for display with the user's user name. Next to first icon area 623 is first medallion area 624. First medallion area 624 includes an indicator denoting a special status of a commenter, such as that of a seller or bidder. A commenter that is only a verified bidder optionally has a different indicator in first medallion area.

This arrangement continues for second verified user name 628 and third verified user name 632, with highlighting, such as underlining or shading in a contrasting color indicating that the user is verified. Second and third icon areas 629 and 633 contain personalized icons preselected by those users. Second medallion area 630 and third medallion area 634 are for display of indicators denoting that the commenter is a seller, bidder or just a verified user. A verified user who may not be bidding or selling but just commenting may be designated by a medallion in his or her medallion area indicating the user is a “super bidder” or has attained some other significant status, as established by the auction administrator. Corresponding comments by a first verified user, a second verified username displayed a first verified user comment 626, second verified user comment 631 and third verified user comment 635. As discussed in connection with FIG. 2, as comments are added, older comments are purged, with most recent comments displayed at the top or bottom of the thread. Optionally, a live video feed of the commenting user is displayed while that user's comment remains as the most recent comment.

As discussed, comments of both verified and unverified users are optionally displayed in a single thread. In such instances, the various icons, medallions and user name differentiation techniques described above are used in the single thread to differentiate those verified posters from unverified and further distinguishing bidders, sellers, and verified spectators.

Continuing with FIG. 2, auction interface 111 includes multimedia fields 220, 222, 224 and 226. Multimedia fields include various data files providing users information about the vehicle currently up for auction. First multimedia field 220 provides an image of a first view of the vehicle identified in vehicle identification field 202. Second multimedia field 222 provides an image of a second view of the same vehicle. Third multimedia field 224 provides an image of the third view of the same vehicle. Fourth multimedia field 226, in one embodiment, provides a video of the vehicle, which may also include audio. Alternatively, multimedia fields 220, 222, 224 and 226 all provide video, photographs or audio files, or some combination of them all. More or fewer multimedia fields may be designated by the auction administrator, offering a tile-like view of more or fewer multimedia files describing the vehicle. Auction interface 111 includes informational field 228 that in one embodiment includes a written narrative describing the various vehicles' features. Informational field 228 in some embodiments includes links that a user may select to be directed to various third party or auction administrator data concerning the vehicle.

Auction interface 111 also includes real time market conditions field 230. Real time market conditions field 230 provides real time information indicative of the seller of the vehicle up for auction, the current high bidder for the vehicle and the most recent overtaken bidder of the vehicle. This information is made available through the interface in textual or video form or a combination of both. In one embodiment, real time market conditions field 230 includes multiple subfields, including seller field 232, leading bidder field 234 and overtaken bidder field 236, which contain live video feeds of these parties during the auction. The video includes accompanying audio. This enables users to enjoy the full reaction of the seller of the status of the bids for his or her vehicle and the reaction of bidders vying for the vehicle, giving users the full flavor of the competitive atmosphere that a high-end vehicle auction brings, which is difficult if not impossible to achieve at a live, solely in person, auction. The content of leading bidder feed 234 and overtaken bidder feed 236 are dynamic in that the content in terms of the user/bidder changes as a new bid is made, with two users potentially toggling back and forth between the lead bid and overtaken bid field, and the reaction of the user's seen with each change.

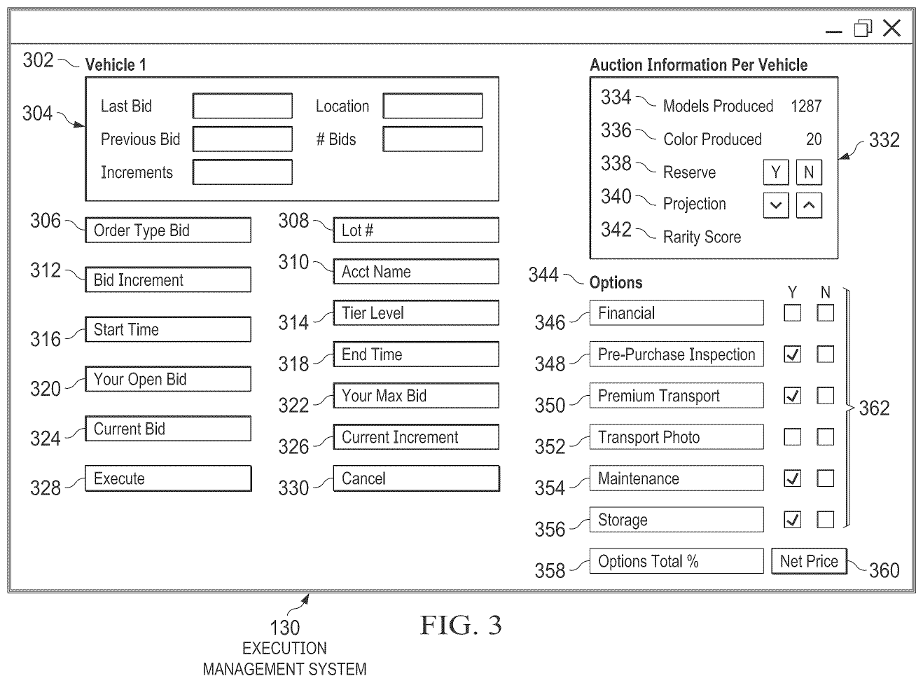

FIG. 3 depicts an execution management system interface according to an embodiment of the presently described auction platform. Execution system management interface 130 in one embodiment is generated by auction content server 102 in conjunction with auction platform application program 156 residing on user device 150. Execution management interface 130 includes a number of fields that relate to the state of the bid of a particular user as well as vehicle information. Various fields of execution management system interface 130 are defined by the user. Execution management system 130 includes vehicle identification field 302 that depicts the vehicle make and model up for auction. Vehicle identification field 302 includes a bid status field 304 including subfield data include the last bid amount, the previous bid amount, the bidding increments for the current vehicle under auction. Order type field 306 indicates whether the user's order is an offer to purchase the vehicle outright or a bid. Lot number field 308 contains the lot number of the vehicle, which uniquely identifies the vehicle up for auction during this particular auction. Lot number in one embodiment is a combination of the make and model of the vehicle, preceded or followed by other numbers or letters having a particular meaning in the context of this auction.

Continuing with FIG. 3, vehicle identification field 302 includes account name field 310 that includes that name of the bidder or a unique identifier of the user that anonymously denotes the user account. Bid increment field 312 indicates the bid increments designated by the auction administrator for the particular vehicle. Tier level field 314 indicates the value level of the vehicle up for auction. A tier level number indicates a lower to higher tier, corresponding to a relatively lower lever to a high level of value of the vehicle. In an embodiment, the lower the level of the tier corresponds to a lower level of bidding increment for that vehicle. By example, a vehicle having a $50,000 value may be designated a tier 1 vehicle, having a corresponding $250 bid increment. At the same time, a $250,000 vehicle may be designated a tier 3 vehicle having a $2,500 bid increment. The auction administrator established the value ranges of the tiers and the corresponding bid increment for each tier. Auction bidding start time field 316 indicates the start time of the auction and end time field 318 indicates the time at which bidding for the vehicle ends. Your opening bid field 320 indicates the user's opening bid for the auction and your maximum bid field 322 indicates the highest bid the user may make. In an automated auction context, the maximum bid field 322 is set by the user as a source of protection against over-bidding on a vehicle beyond a predefined limit of the user. Current bid field 324 indicates the current bid outstanding on the current vehicle and current increment field 326 indicates the increment currently in play for the vehicle under bid.

Continuing, execution management system interface 130 includes auction information provided on a per vehicle basis. Auction information field 332 includes models produced field 334 that indicates the total number of models produced of the particular vehicle model. Color field 336 indicates the number of models produced of the vehicle model in the color of the vehicle. In the example provided, 1287 units of the particular vehicle were manufactured and twenty were produced in the color of the vehicle at auction. Reserve field 338 indicates where there is a reserve in place for the vehicle auction, meaning that a minimum bid value must be reached or surpassed in order for the vehicle to be sold. If the answer in reserve field 338 is “no”, then the auction is “absolute”, meaning the vehicle will be sold at the high bid regardless of the amount of the bid. Projection field 340 provides a “yes” or “no” indication of whether the projected sale price is above or below the value of the vehicle determined pre-auction. Rarity score field 342 indicates on a scale, in one embodiment from 1 to 10, with 10 being the most rare, indicating the relative rarity of the vehicle up for auction. Rarity is determined by a number of factors, including the aforementioned number of units manufactured and the number of units manufactured or available in the color of the vehicle up for auction.

Continuing with FIG. 3, execution management system interface 130 includes options field 344. Options field 344 includes one or more user selectable options the user can select for a fee in connection with the vehicle up for auction. Some of these options are contingent on the user submitting the winning bid for the vehicle. Others are not win-dependent. The user selects “yes” or “no” in selection field 362 at the side of each of the option fields. Financing field 346 allows the user to select if he would like a referral and to make arrangements for financing the purchased vehicle. Pre-purchase inspection field 348 is selected if the user wishes to obtain a vehicle inspection prior to auction. Premium transport service allows the user to select a custom vehicle delivery service. Associated transport photography field 352 is selected if the user wishes to receive periodic photographs of the vehicle in transit, both before the auction and following purchase of the vehicle. Maintenance option field 354 is selected if the user wishes to enroll in various levels of a maintenance plan for the vehicle. Storage field 356 is selected if rather than taking physical delivery of the vehicle, the user wishes to place the vehicle in a high-end storage facility.

Options total field 358 indicates by percentage of the winning auction price the cost of the various selected options. Net price field 360 indicates the net price of the options selected plus the vehicle winning bid amount. In one embodiment additional services may be purchased by the user, such as financing services to finance the vehicle purchased, purchase of a warranty and purchase of insurance coverage for the vehicle. Information such as automotive guidance, vehicle listing guidance and automotive collection guidance is also made available to users via one or more of the herein described auction platform interfaces.

Once the user makes the various selections or inputs to the various fields of execution management system interface 130, the user selects execute key 328 to place the order for options and select the various bidding parameters set in the interface. If, however, the user wishes to reset the choices or cancel the order altogether, the user selects cancel key 330 and the order and amounts or data entered in the various fields are cleared.

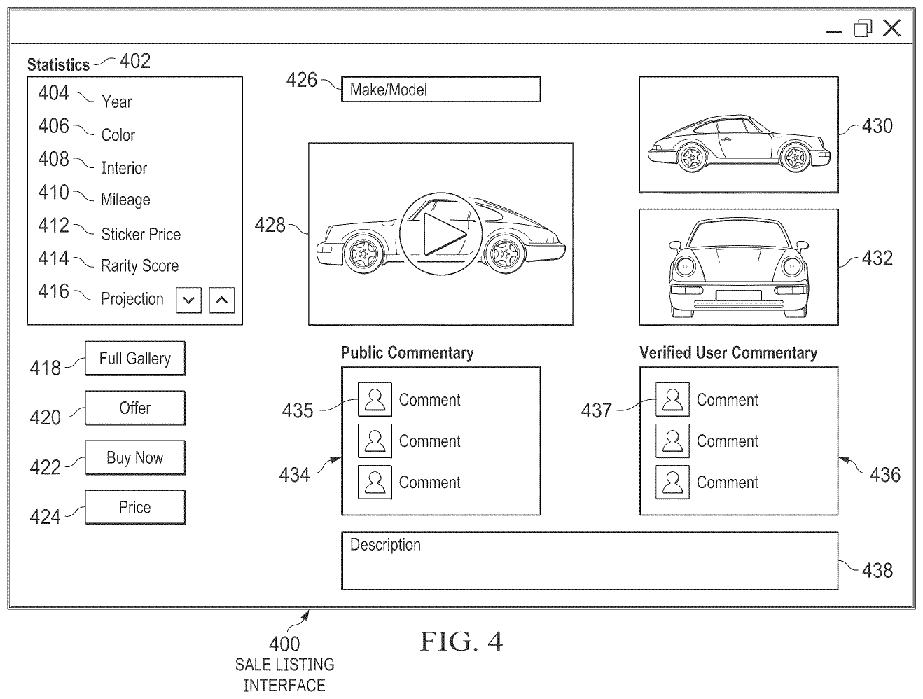

FIG. 4 depicts a sale listing interface 400 according to an embodiment of the presently described auction platform. Sale listing interface 400 in one embodiment is generated by auction content server 102 in conjunction with auction platform application program 156 residing on user device 150. Sale listing interface 400 presents a listing of vehicles that may have not been sold at auction due to the reserve price not being met, or a user wishing to sell a vehicle outside of an auction context in the first instance. Auction content server 102 causes sale listing interface 400 to be presented to a user on the display screen of a user's device such as mobile device 150 via dedicated auction platform application program 156 downloaded to the user's device, as described. The seller of a vehicle via the presently described auction platform, in one embodiment, chooses to automatically place the vehicle among the vehicles listed for sale in sale listing interface 400 at the time the seller places the vehicle for auction. In this manner, auction content server 102 periodically sweeps vehicles not sold via the auction process and adds those vehicles pre-selected by the user among the vehicles listed on sale listing interface 400. In another embodiment, the seller may optionally designate listing the unsold vehicle on sale listing interface 400 at a time later than when setting the vehicle for auction.

Vehicles for direct sale are listed with or without a thumbnail photograph of the vehicle next to general information about the vehicle, such as the vehicle name and model, year and price. The user may select a vehicle to receive more information via a hyperlink of other selectable means as known in the art to direct the user to a more granular webpage including information about the vehicle. Sale listing interface 400 as shown in FIG. 4 depicts what the user is presented with upon selection of a specific vehicle from the list. Sale listing interface 400 includes various statistics fields 402 that provide detailed information of the vehicle offered for sale. Statistics field 402 includes various subfields, including the year of the vehicle in year field 404, the color of the vehicle in color field 406, the interior color of the vehicle in interior field 408 and the mileage of the vehicle in mileage field 410. Also, statistics field 402 includes sticker price field 412 indicating the asking price for the vehicle. Rarity score field 414 includes a value for a rarity score, which as discussed is a value within a low to high range of values that is an indication of the rareness of the vehicle, taking into account a number of variables. Statistics field 402 also includes projection field 416 which in one embodiment provides an “up” or “down” indication related to whether the value of the vehicle is trending up or down based on a variety of market conditions.

Sale listing interface 400 also includes full gallery key 418, allowing the user to toggle back to the full gallery of all vehicles offered for sale outside of the auction setting. Offer key 420 permits the user to make an offer for the vehicle, which may be above or below the sticker price. Field 422 is a “buy now” key that enables the user to pay asking or sticker price for the vehicle without negotiation. Price field 424 includes the asking price of the vehicle.

Continuing with FIG. 4, sale listing interface 400 includes numerous multimedia screens 428, 430 and 432 that depict various visual information concerning the vehicle. These screens include video footage or still photographs of the vehicle, all of one type or a combination of both. Vehicle make and model field 426 includes the make and model of the vehicle.

Sale listing interface 400 also includes chatrooms where individuals post comments concerning the vehicle for sale. Public commentary chat 434 includes a listing of public comments, optionally including an icon 435 or other identifier of the commentator. Verified user commentary chat 436 includes various comments posted by various users. Optionally, an icon 437 or other indicators of the posting verified user commentator is provided next to the commenter's comment. Comments related to the sale of the vehicle are stored in vehicle database 105 by auction content server 102 with other vehicle data.

Sale listing interface 400 also includes a vehicle description field 438 that includes description, features, specifications and other information concerning the vehicle retrieved from various third-party vehicle information servers 172 and aggregated by auction platform 100. Vehicle description field also includes content concerning the vehicle created by the auction administrator. Optionally, vehicle description field 438 includes hyperlinks or other user activatable buttons that direct the user directly to information regarding the vehicle for sale on the listing.

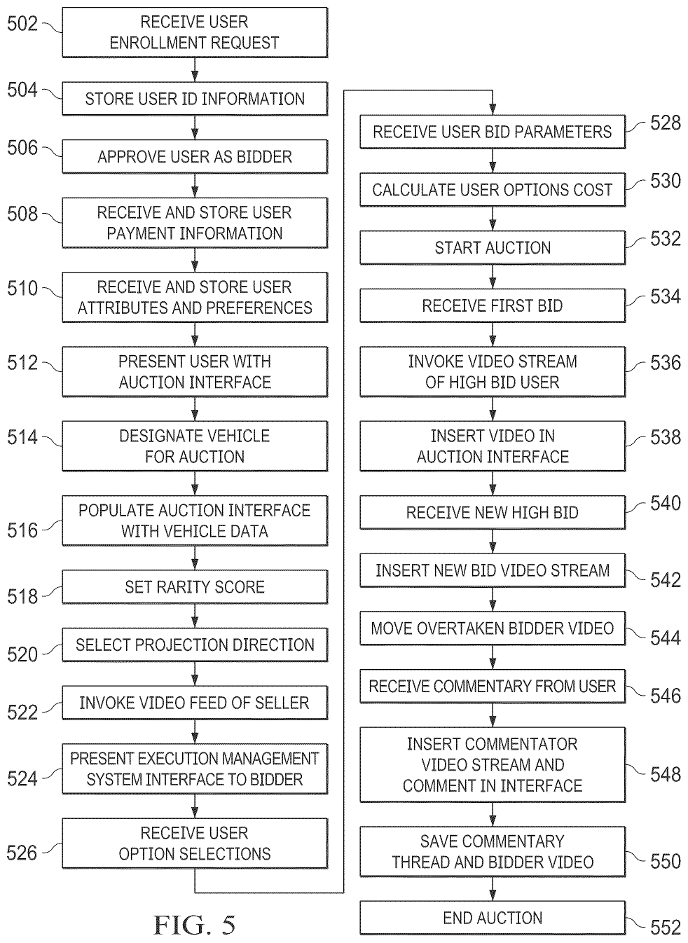

FIG. 5 is a flow diagram of a method performed by or in connection with the auction platform according to an embodiment. The method of FIG. 5 begins with enrollment of a user wishing to bid at auction and at step 502 auction platform 100 receives a user request to enroll as a bidder. In the process of receiving the user request, the user provides various user information to auction platform 100. This information is stored at step 504 in user database 107. Next the user undergoes an approval process to determine if he or she meets the qualifications to participate as a bidder in a vehicle auction. Assuming the user meets the participation criteria, at step 506 the user is approved as a bidder. Next, at step 508 the user's payment information is stored in user database 107. This payment information takes various forms including credit or debit card information to pay for monthly subscription service to the auction platform, if applicable, and bank account information from which winning bid amounts for the user are drawn.

Continuing at step 10 auction platform 100 stores in user database user defined attributes and preferences. These user defined attributes and preferences include but are not limited to a geographic location of the user, particular goods and services of interest of the user, including particular vehicles for which the user wishes to be notified are included in upcoming auctions, user photographs for presentation in connection with the user's profile and the like. Next, at step 512 the user is presented with an auction interface that depicts various vehicles up for auction. Upon receipt of a user designation of a particular vehicle of interest at step 514 on which the user wishes to bid, the auction interface is populated at step 516 with vehicle data. Such vehicle data includes multimedia data such as photographs and video footage of the vehicle, the make, model, color and mileage of the vehicle, and other pertinent information. Among the information inserted in auction interface 111 is a set rarity score at step 518 and a projection direction at step 520. A rarity score is presented in auction interface 111 in one embodiment as a value within a range of values, the endpoints set to represent low rarity and high rarity, with the specific vehicle falling somewhere within the range. The rarity score is set according to various factors concerning the vehicle including number of units of the model manufactured and the number manufactured of the color of the vehicle up for auction. Projection direction indicates in which direction the value of the vehicle is trending, either higher or lower than the stated or expected value or range that will likely be paid by the winning bidder. Projection direction gives the user/bidder an indication of the level of competition for the vehicle and the likelihood of a bidding war.

Continuing with FIG. 5, at step 522 the application program residing on the various user devices invokes the video capability on the vehicle seller's device. This permits a bidder to view the reaction of the seller during live bidding to enhance the user experience. The video stream is inserted into a designated area of auction platform 111 and remains throughout that vehicle's auction process. Next at step 524, an execution management system interface 130 is presented to the bidder. This permits the user to view his predefined parameters of the auction, such as the maximum bid and bid increments that the user chooses, in addition to information about the vehicle up for auction. The execution management system interface provides the user with a list of selection (See FIG. 3) for ancillary services and/or products that the user may deem beneficial prior to bidding and in the event that the user is the winning bidder. Once the user selects various options, at step 526 options are submitted by the user and received by the auction content server 102 at step 528. Next, a cost calculation for the options is made by auction content server 102 at step 530 and saved accordingly.

At step 532, the vehicle auction begins. In some embodiments, the auction is set for a finite duration with a predefined start and finish time. Also, the auction may be “with reserve” or “absolute”. With reserve means that unless at least a minimum bid is received, the vehicle will not be sold at auction. Conversely, if the auction for the vehicle is designated as absolute, the vehicle will be sold regardless of the amount of the bid.

Next, at step 534, server 102 receives a first bid for the vehicle. Upon receipt, a video link is invoked at step 536 on the mobile device of the first or current high bidder for the vehicle. At step 538, content server 102 causes a video stream of the high bidder to be inserted into a designated field of auction platform 111 for the current high bidder. This allows users to view the reaction of the leading bidder. Continuing at step 540, a new high bid is received from a different user and at step 542 the video link is invoked on the new high bidder/user mobile device via the user's mobile application program and the video stream of the new high bidder is placed in the designated area for the current high bidder on auction interface 111, with the video stream of the now overtaken bidder moved at step 544 to the area on interface 111 designated for the overtaken bidder. This movement or hierarchy of high bidders and overtaken bidders allows users to view the competitive nature of the auction setting, watching in real time the joy or dismay of bidders changing quickly with receipt of new bids.

Continuing with FIG. 5, in parallel with the placement of initial bids on the vehicle up for auction, the commentary capability of the presently described auction platform is invoked and at step 546, commentary from one or more users is received by content platform 102. In connection with the posting of comments by a user, which are akin to a text message sent or received in SMS format, the contents of the post are inserted in auction interface 111 at step 548 in the designated user commentary area and a video stream of the commenting user is inserted at the designated area in the interface. The commentary posted over the course of the auction appears as would a text thread and the collective commentary and video footage of bidders and commentators is saved in vehicle database 105 by auction content server 102 at step 550. The archiving of the commentary and video of commenters and bidders, as well as how the auction evolved, allows later viewing of the auction experience, allowing users to reexperience the highs and lows of the auction and any bragging or “trash talking” that may have occurred during the auction process. Finally, at step 552, the auction ends with a winning bidder declared.

While the above-described flowcharts have been discussed in relation to a particular sequence of events, it should be appreciated that one or more changes to this sequence can occur without materially affecting the operation of the embodiments. Additionally, the exact sequence of events need not occur as set forth in the exemplary embodiments. The exemplary techniques illustrated herein are not limited to the specifically illustrated embodiments but can also be utilized with the other exemplary embodiments and each described feature is individually and separately claimable. Moreover, the steps in the flowcharts are optional, with some or all of the steps being performed.

The above-described methods and systems and can be implemented in a software module, a software and/or hardware testing module, a telecommunications test device, a DSL modem, an ADSL modem, an xDSL modem, a VDSL modem, a linecard, a G.hn transceiver, a MOCA transceiver, a Homeplug® transceiver, a powerline modem, a wired or wireless modem, test equipment, a multicarrier transceiver, a wired and/or wireless wide/local area network system, a satellite communication system, network-based communication systems, such as an IP, Ethernet or ATM system, a modem equipped with diagnostic capabilities, or the like, or on a separate programmed general purpose computer having a communications device or in conjunction with any of the following communications protocols. CDSL, ADSL2, ADSL2+, VDSL1, VDSL2, HDSL, DSL Lite, IDSL, RADSL, SDSL, UDSL, MOCA, G.hn, Homeplug® or the like.

Additionally, the systems, methods and protocols of this invention can be implemented on a special purpose computer, a programmed microprocessor or microcontroller and peripheral integrated circuit element(s), an ASIC or other integrated circuit, a digital signal processor, a flashable device, a hard-wired electronic or logic circuit such as discrete element circuit, a programmable logic device such as PLD, PLA, FPGA, PAL, a modem, a transmitter/receiver, any comparable means, or the like. In general, any device (or one or more equivalent means) capable of implementing a state machine that is in turn capable of implementing the methodology illustrated herein can be used to implement the various communication/measurement methods, protocols, and techniques according to this invention.

Furthermore, the disclosed methods may be readily implemented in software stored on a non-transitory computer-readable storage media using object or object-oriented software development environments that provide portable source code that can be used on a variety of computer or workstation platforms. Alternatively, the disclosed system may be implemented partially or fully in hardware using standard logic circuits or VLSI design. Whether software or hardware is used to implement the systems in accordance with this invention is dependent on the speed and/or efficiency requirements of the system, the particular function, and the particular software or hardware systems or microprocessor or microcomputer systems being utilized. The communication systems, methods and protocols illustrated herein can be readily implemented in hardware and/or software using any known or later developed systems or structures, devices and/or software by those of ordinary skill in the applicable art from the functional description provided herein and with a general basic knowledge of the computer and telecommunications arts.

Modifications, additions, or omissions can be made to the methods depicted in FIGS. 3-5. The method can include more, fewer, or other steps. For example, steps can be performed in parallel or in any suitable order. While discussed as estimate generating system 100 (or components thereof) performing the steps, any suitable component of the estimate generating system can perform one or more steps of the method.

Although the present disclosure includes several embodiments, a myriad of changes, variations, alterations, transformations, and modifications may be suggested to one skilled in the art, and it is intended that the present disclosure encompass such changes, variations, alterations, transformations, and modifications as falling within the scope of the appended claims.

Clause 1. A live auction system, comprising
a processor; and
a computer-readable medium having instructions stored thereon that, when executed by the processor, cause the processor to manage a live auction, the managing comprising:
receiving, from a remote user device having stored thereon an application program for user customization of interface data, user selection of user experience interface attributes;
receiving a bid from the remote user device for an auction item;
defining a customizable user experience interface according to received user experience interface attributes; the customizable user experience interface comprising:
   a first display area for display of a first live video feed of a seller of the auction item;
   a second display area for display of a second live video feed of a leading bidder placing a current high bid for the auction item;
   a third display area for display of a first outbid bidder live video feed placing a previous high bid for the auction item;
   an auction item information area for display of multimedia and textual information associated with the auction item;
   a first message area for dynamically displaying in real time a communication posted by and between users in a first user category; and
   a second message area for dynamically displaying in real time a communication posted by and between users in a second user category.

Clause 2. The system of any preceding or proceeding clause, further comprising the computer-readable medium having instructions stored thereon that, when executed by the processor, cause the processor to manage a live auction, the managing comprising displaying within the first messaging area the first outbid bidder live video feed placing a previous high bid for the auction item.

Clause 3 The system of any preceding or proceeding clause, further comprising a first ranking indicator displayed with the real time communication posted by and between users in the first user category first category of users; and
a second ranking indicator displayed with the real time communication posted by and between users in the first user category first class of users,
wherein the first ranking indicator associated with users in the first user category defines a first status of the first user category and the second ranking indicator associated with users in the first user category defines a second status of the first user category.

Clause 4. The system of any preceding or proceeding clause, wherein the auction item comprises a vehicle.

Clause 5. The system of any preceding or proceeding clause, wherein the multimedia and textual information associated with the auction item comprises auction item rarity and trending data.

Clause 6. The system of any preceding or proceeding clause, wherein the auction item rarity and trending data comprises real time data based on market conditions for the auction item.

Clause 7. The system of any preceding or proceeding clause, further comprising the computer-readable medium having instructions stored thereon that, when executed by the processor, cause the processor to manage a live auction, the managing further comprising communicating over a network with a third party auction item information service to retrieve the multimedia and textual information associated with the auction item.

Clause 8. The system of any preceding or proceeding clause, further comprising the computer-readable medium having instructions stored thereon that, when executed by the processor, cause the processor to manage a live auction, the managing further comprising communicating over a network with a third party a third party financing service.

Clause 9. The system of any preceding or proceeding clause, further comprising the computer-readable medium having instructions stored thereon that, when executed by the processor, cause the processor to manage a live auction, the managing further comprising communicating over a network with a social media platform.

Clause 10. The system of any preceding or proceeding clause, further comprising the computer-readable medium having instructions stored thereon that, when executed by the processor, cause the processor to manage a live auction, the managing further comprising archiving an auction record in a storage medium.

Clause 11. The system of any preceding or proceeding clause, further comprising the computer-readable medium having instructions stored thereon that, when executed by the processor, cause the processor to manage a live auction, the managing further comprising replacing within the first messaging area the first outbid bidder live video feed with a second outbid bidder live video feed upon receipt of a subsequent bid.

Clause 12. The system of any preceding or proceeding clause, further comprising the computer-readable medium having instructions stored thereon that, when executed by the processor, cause the processor to manage a live auction, the managing further comprising changing, in the second display area, the second live video feed of the leading bidder upon receipt of a subsequent bid.

Clause 13. The system of any preceding or proceeding clause, wherein the multimedia and textual information associated with the auction item comprises a vehicle make, a vehicle model, a vehicle color and a vehicle score.

Clause 14. The system of any preceding clause, wherein the auction item rarity and trending data comprises data associated with the number of units manufactured of the auction item and the number of units of the auction item manufactured in a particular color.

Clause 15. A method for conducting a live auction by receiving user bids from remote user devices, comprising the steps of:
receiving a user enrollment request from a first user ad from a second user, including user attribute and preference selections;
generating a first user experience interface reflecting the first user's attribute and preference selections;
generating a second user experience interface reflecting the second user's attribute and preference selections;
presenting the user experience interface to a remote user device via a communication over a network;
designating an auction item for sale via the live auction;
   setting parameters for the auction,
populating the user experience interface with auction item information;
calculating an auction item rarity value and an auction item trending value;
displaying a live video stream of a seller of the auction item for sale;
receiving a first user bid from a first user via the first user experience interface;
displaying in real time in a high bidder display area, in response to receipt of the first user bid, a first user live video stream;
displaying, in real time during the auction, a first communication string comprised of messages posted of authorized users during receipt of auction bids;
receiving a second user bid from a second user via the second user experience interface;
replacing, in response to receipt of the second user bid, the first user live video stream displayed in the high bidder display area with a second user live video stream;
inserting, in response to receipt of the second user bid, the first user live video stream in a display area for displaying the first communication string;
updating the first communication string according to messages received from an at least one authorized bidder;
presenting a second communication string in response to a message received from an at least one non-bidding user;
receiving a final auction bid; and
identifying a winner of the auction item according to an identity associated with the final auction bid.

Clause 16. The method of any preceding or proceeding clause, wherein the auction parameters comprise an auction start time, a bid increment and a reserve status.

Clause 17 The method of any preceding or proceeding clause, wherein the user preferences comprise a pre-purchase inspection; auction item transport; an auction item maintenance plan; auction item storage and auction item financing.

Clause 18. The method of any preceding clause, wherein the message of the first communication string and the messages of the second communication string are short messaging service (SMS) messages.

What is claimed:

1. A live auction system, comprising
a processor; and
a computer-readable medium having instructions stored thereon that, when executed by the processor, cause the processor to manage a live auction, the managing comprising:
receiving, from a remote user device having stored thereon an application program for user customization of interface data, user selection of user experience interface attributes;
receiving a bid from the remote user device for an auction item;
defining a customizable user experience interface according to received user experience interface attributes; the customizable user experience interface comprising:
a first display area for display of a first live video feed of a seller of the auction item;
a second display area for display of a second live video feed of a leading bidder placing a current high bid for the auction item;
a third display area for display of a first outbid bidder live video feed placing a previous high bid for the auction item;
an auction item information area for display of multimedia and textual information associated with the auction item;
a first message area for dynamically displaying in real time a communication posted by and between users in a first user category; and
a second message area for dynamically displaying in real time a communication posted by and between users in a second user category.

2. The system of claim 1, further comprising the computer-readable medium having instructions stored thereon that, when executed by the processor, cause the processor to manage a live auction, the managing comprising displaying within the first messaging area the first outbid bidder live video feed placing a previous high bid for the auction item.

3. The system of claim 1, further comprising a first ranking indicator displayed with the real time communication posted by and between users in the first user category first category of users; and
a second ranking indicator displayed with the real time communication posted by and between users in the first user category first class of users,
wherein the first ranking indicator associated with users in the first user category defines a first status of the first user category and the second ranking indicator associated with users in the first user category defines a second status of the first user category.

4. The system of claim 1, wherein the auction item comprises a vehicle.

5. The system of claim 1, wherein the multimedia and textual information associated with the auction item comprises auction item rarity and trending data.

6. The system of claim 5, wherein the auction item rarity and trending data comprises real time data based on market conditions for the auction item.

7. The system of claim 1, further comprising the computer-readable medium having instructions stored thereon that, when executed by the processor, cause the processor to manage a live auction, the managing further comprising communicating over a network with a third party auction item information service to retrieve the multimedia and textual information associated with the auction item.

8. The system of claim 1, further comprising the computer-readable medium having instructions stored thereon that, when executed by the processor, cause the processor to manage a live auction, the managing further comprising communicating over a network with a third party a third party financing service.

9. The system of claim 1, further comprising the computer-readable medium having instructions stored thereon that, when executed by the processor, cause the processor to manage a live auction, the managing further comprising communicating over a network with a social media platform.

10. The system of claim 1, further comprising the computer-readable medium having instructions stored thereon that, when executed by the processor, cause the processor to manage a live auction, the managing further comprising archiving an auction record in a storage medium.

11. The system of claim 2, further comprising the computer-readable medium having instructions stored thereon that, when executed by the processor, cause the processor to manage a live auction, the managing further comprising replacing within the first messaging area the first outbid bidder live video feed with a second outbid bidder live video feed upon receipt of a subsequent bid.

12. The system of claim 1, further comprising the computer-readable medium having instructions stored thereon that, when executed by the processor, cause the processor to manage a live auction, the managing further comprising changing, in the second display area, the second live video feed of the leading bidder upon receipt of a subsequent bid.

13. The system of claim 4, wherein the multimedia and textual information associated with the auction item comprises a vehicle make, a vehicle model, a vehicle color and a vehicle score.

14. The system of claim 5, wherein the auction item rarity and trending data comprises data associated with the number of units manufactured of the auction item and the number of units of the auction item manufactured in a particular color.

15. A method for conducting a live auction by receiving user bids from remote user devices, comprising the steps of:
receiving a user enrollment request from a first user ad from a second user, including user attribute and preference selections;
generating a first user experience interface reflecting the first user's attribute and preference selections;
generating a second user experience interface reflecting the second user's attribute and preference selections;
presenting the user experience interface to a remote user device via a communication over a network;
designating an auction item for sale via the live auction;
setting parameters for the auction;
populating the user experience interface with auction item information;
calculating an auction item rarity value and an auction item trending value;
displaying a live video stream of a seller of the auction item for sale;
receiving a first user bid from a first user via the first user experience interface;
displaying in real time in a high bidder display area, in response to receipt of the first user bid, a first user live video stream;
displaying, in real time during the auction, a first communication string comprised of messages posted of authorized users during receipt of auction bids;
receiving a second user bid from a second user via the second user experience interface;
replacing, in response to receipt of the second user bid, the first user live video stream displayed in the high bidder display area with a second user live video stream;
inserting, in response to receipt of the second user bid, the first user live video stream in a display area for displaying the first communication string;
updating the first communication string according to messages received from an at least one authorized bidder;
presenting a second communication string in response to a message received from an at least one non-bidding user;
receiving a final auction bid; and
identifying a winner of the auction item according to an identity associated with the final auction bid.

16. The method of claim 16, wherein the auction parameters comprise an auction start time, a bid increment and a reserve status.

17. The method of claim 16, wherein the user preferences comprise a pre-purchase inspection; auction item transport; an auction item maintenance plan; auction item storage and auction item financing.

18. The method of claim 16, wherein the message of the first communication string and the messages of the second communication string are short messaging service (SMS) messages.
